(19) United States
(12) Patent Application Publication
(10) Pub. No.: US 2010/0063777 A1
(43) Pub. Date: Mar. 11, 2010

(54) Power Aware Techniques for Energy Harvesting Remote Sensor Systems

(75) Inventors: Ertugrul Berkcan, Clifton Park, NY (US); Emad Andarawis, Ballston Lake, NY (US); Eladio Delgado, Burnt Hills, NY (US); Samantha Rao, Bangalore (IN)

Correspondence Address: BRACEWELL & GIULIANI LLP, P.O. BOX 61389, HOUSTON, TX, 77208-1389, US

(73) Assignee: LOCKHEED MARTIN CORPORATION, Bethesda, MD (US)

(21) Appl. No.: 12/208,222

(22) Filed: Sep. 10, 2008

(51) Int. Cl. G06F 11/30

(52) U.S. Cl. 702/188

(57) ABSTRACT

A monitoring system for an aircraft.

### 1. BACKGROUND

This disclosure relates to monitoring systems for aircraft.

### BRIEF DESCRIPTION OF THE DRAWINGS

FIG. 1 is an illustration of an exemplary embodiment of an aircraft monitoring system.

FIG. 2 is a schematic illustration of the aircraft monitoring system of FIG. 1.

FIG. 3 is a schematic illustration of an exemplary embodiment of sensor nodes of the aircraft monitoring system of FIG. 2.

FIGS. 4a and 4b are flow chart illustrations of an exemplary embodiment of a method of operating the sensor nodes of FIG. 3.

FIGS. 5a and 5b are flow chart illustrations of an exemplary embodiment of a method of operating the sensor nodes of FIG. 3.

FIG. 6 is a schematic illustration of an exemplary embodiment of an aircraft monitoring system.

FIG. 7 is a schematic illustration of an exemplary embodiment of an aircraft monitoring system.

FIG. 8 is a flow chart illustration of a method of operating an aircraft monitoring system.

### DETAILED DESCRIPTION

In the drawings and description that follows, like parts are marked throughout the specification and drawings with the same reference numerals, respectively. The drawings are not necessarily to scale. Certain features of the invention may be shown exaggerated in scale or in somewhat schematic form and some details of conventional elements may not be shown in the interest of clarity and conciseness. The present invention is susceptible to embodiments of different forms. Specific embodiments are described in detail and are shown in the drawings, with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce desired results. The various characteristics mentioned above, as well as other features and characteristics described in more detail below, will be readily apparent to those skilled in the art upon reading the following detailed description of the embodiments, and by referring to the accompanying drawings.

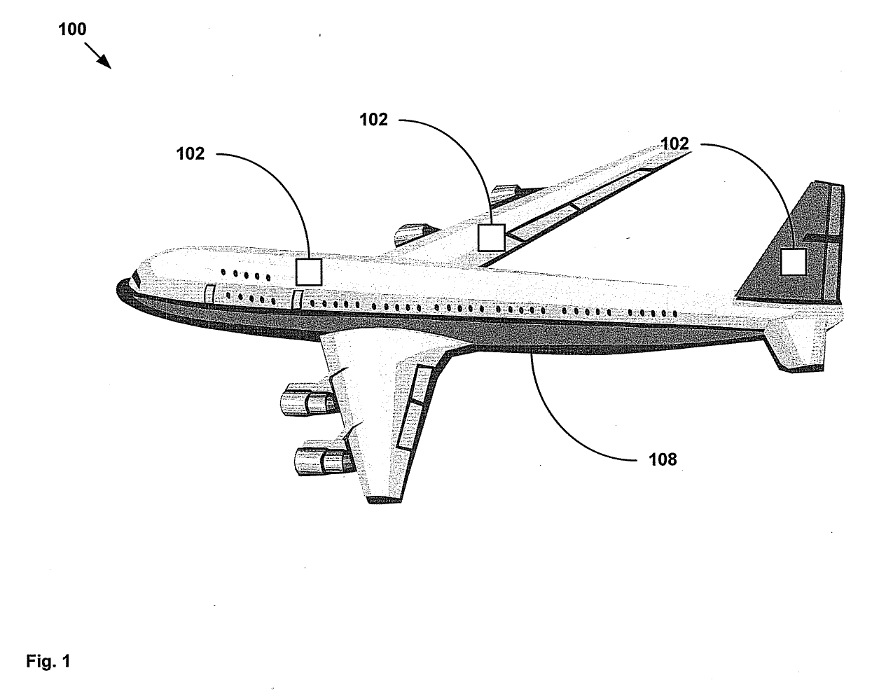

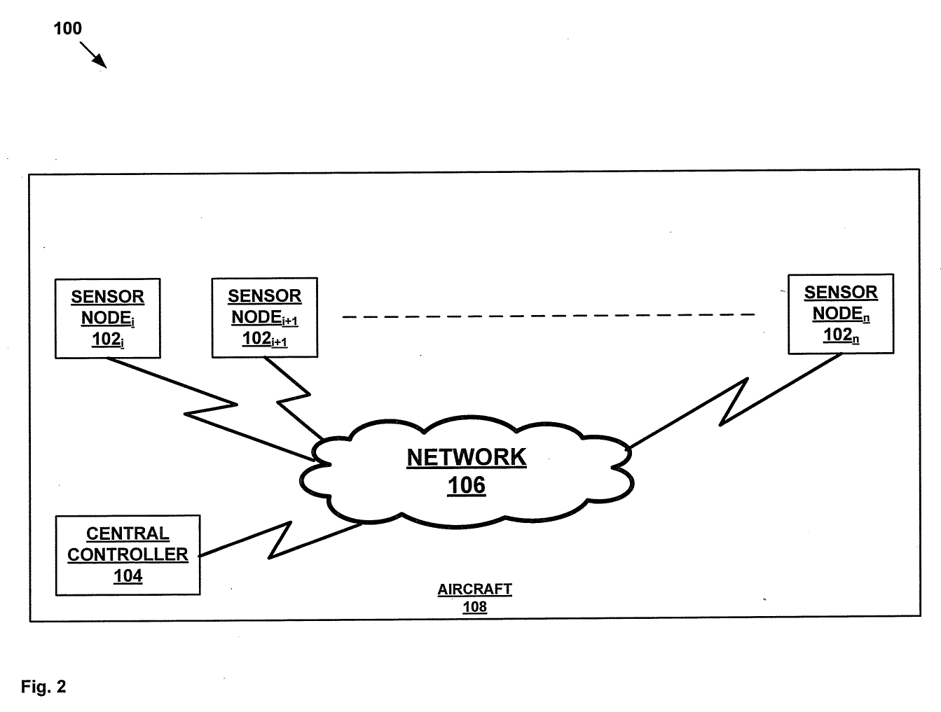

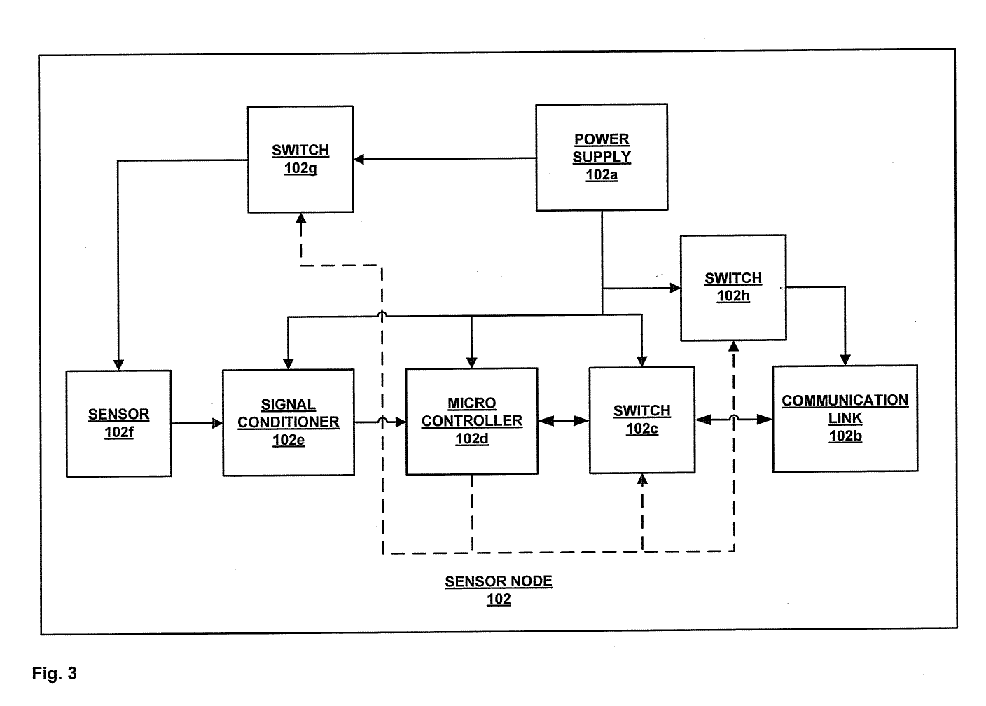

Referring to FIGS. 1-3, an exemplary embodiment of a system 100 for monitoring an aircraft includes one or more sensors nodes 102 that are operably coupled to a central controller 104 by a network 106. In an exemplary embodiment, the sensor nodes 102 are distributed within an aircraft 108 for monitoring one or more operational states of the aircraft that may, for example, include stresses, strains, temperatures, and pressures. In an exemplary embodiment, one or more of the sensor nodes 102 communicate the operational states of the aircraft 108 to the central controller 106 that is housed within the aircraft using, for example, a network 106 that may, for example, include a hard wired, fiber optic, infra red, radio frequency, or other communication pathway.

In an exemplary embodiment, each sensor node 102 includes a power supply 102a that is adapted to scavange energy from the immediate environment. In an exemplary embodiment, the power supply 102a may, for example, scavenge electromagnetic energy, vibrational energy, heat energy, and/or wind energy from the immediate environment. In an exemplary embodiment, the power supply 102a is operably coupled, and supplies power, to a communication link 102b, a switch 102c, a micro-controller 102d, a signal conditioner 102e, a sensor 102f, a switch 102g, and a switch 102h.

In an exemplary embodiment, the communication link 102b is also operably coupled to the switch 102c and adapted to transmit and receive communication signals between the sensor node 102 and the network 106. In this manner, the sensor node 102 may communicate with other sensor nodes and the central controller 104.

In an exemplary embodiment, the switch 102c is also operably coupled to the communication link 102b and the micro-controller 102d and adapted to be controlled by the micro-controller to thereby communications between the communication link and the micro-controller. In this manner, in the event that the micro-controller 102d determines that communication should not occur between the communication link 102b and the micro-controller such as, for example, if the sensor node 102 lacks sufficient power, the micro-controller may operate the switch to prevent communication between the communication link and the micro-controller. In an exemplary embodiment, the switch 102c may, for example, be a mechanical, electrical, or a logical switch.

In an exemplary embodiment, the micro-controller 102d is also operably coupled to the communication link 102b, the switch 102c, the signal conditioner 102e, the sensor 102f, and the switch 102g for monitoring and controlling the operation of each. In an exemplary embodiment, the micro-controller 102d may include, for example, a conventional general purpose programmable controller.

In an exemplary embodiment, the signal conditioner 102e is also operably coupled to the micro-controller 102d and the sensor 102 and adapted to condition signals transmitted by the sensor before they are further processed by the micro-controller. In an exemplary embodiment, the signal conditioner 102e may, for example, include one or more conventional signal processing elements such as, for example, filters, amplifiers, and analog to digital converters.

In an exemplary embodiment, the sensor 102f is also operably coupled to the signal conditioner 102e and the switch 102g and adapted to sense one or more operating conditions of the aircraft 108 in the immediate environment. In an exemplary embodiment, the sensor 102f may include, for example, one or more of the following: a strain gauge, a stress sensor, a temperature gauge, a pressure gauge, an radiation detector, a radar detector, and/or a detector of electromagnetic energy.

In an exemplary embodiment, the switch 102g is also operably coupled to the micro-controller 102d and the sensor 102f and adapted to control the operation of the sensor under the controller of the micro-controller. In this manner, in the event that the micro-controller 102d determines that the sensor 102f should not operate such as, for example, if the sensor node 102 lacks sufficient power, the micro-controller may operate the switch 102g to prevent power from being supplied by the power supply 102a to the sensor.

In an exemplary embodiment, the switch 102h is also operably coupled to the micro-controller 102d and the communication link 102b and adapted to control the operation of the communication link under the controller of the micro-controller. In this manner, in the event that the micro-controller 102d determines that the communication link 102b should not operate such as, for example, if the sensor node 102 lacks sufficient power, the micro-controller may operate the switch 102h to prevent power from being supplied by the power supply 102a to the communication link.

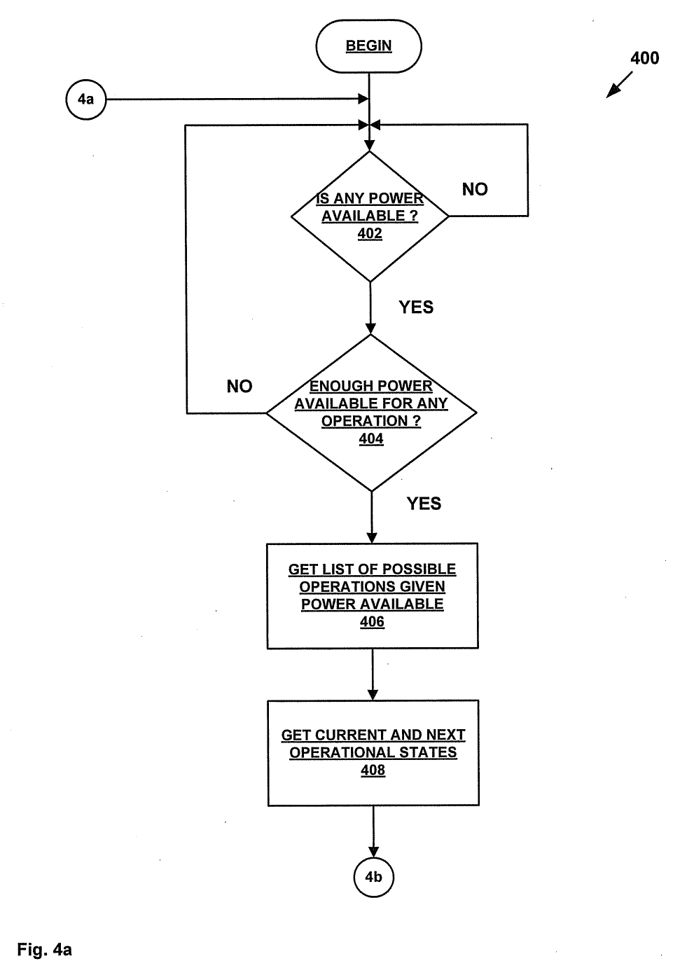

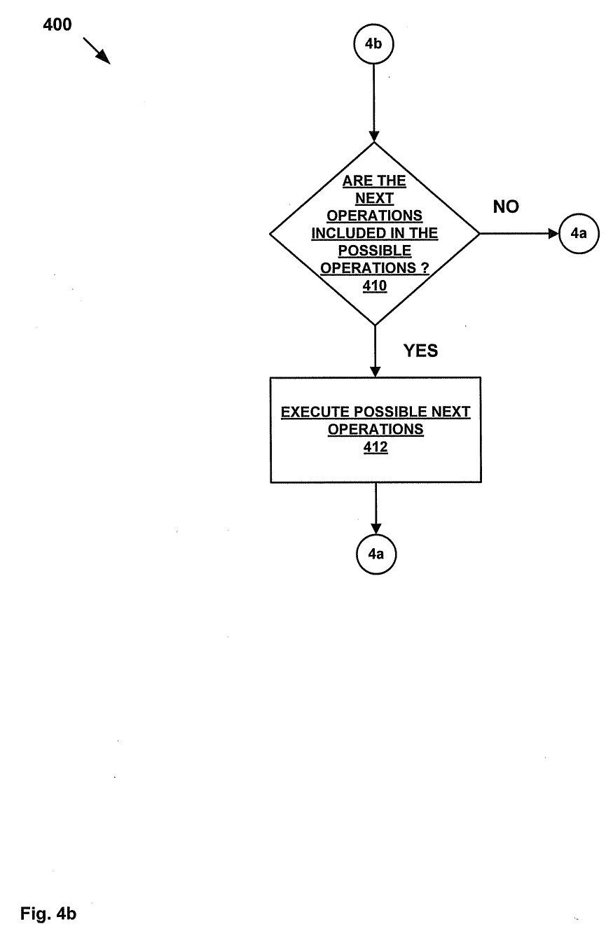

Referring now to FIGS. 4a and 4b, in an exemplary embodiment, one or more of the sensor nodes 102 of the system 100 implement a method 400 of operating in which, in 402, the sensor node determines if there is any power available to the sensor node. If there is any power available to the sensor node 102, then the sensor node determines if there is enough power available to the sensor node to permit the sensor node to execute at least one operation in 404.

If there is enough power available to permit the sensor node 102 to execute at least one operation, then the sensor gets a listing of the possible operations given the amount of available power in 406. The sensor node 102 then gets a listing of the current and next operational states for the sensor node in 408.

The sensor node 102 then determines if the next operational states of the sensor node are included in the possible operations given the amount of available power in 410. If the next operational states of the sensor node 102 are included in the possible operations given the amount of available power, then the sensor node executes the next operational states that are possible to execute given the amount of available power in 412.

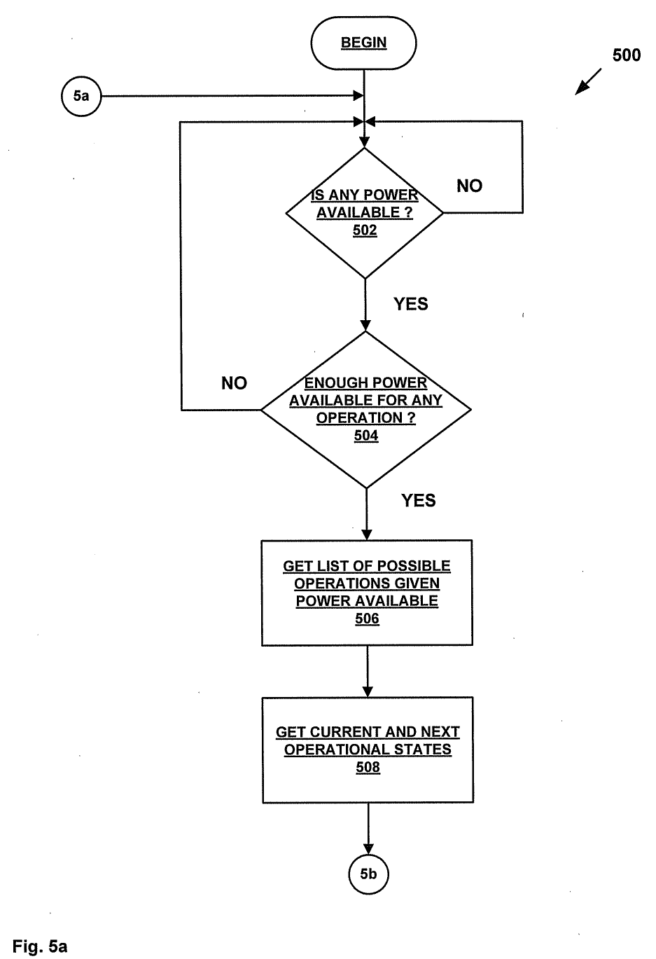

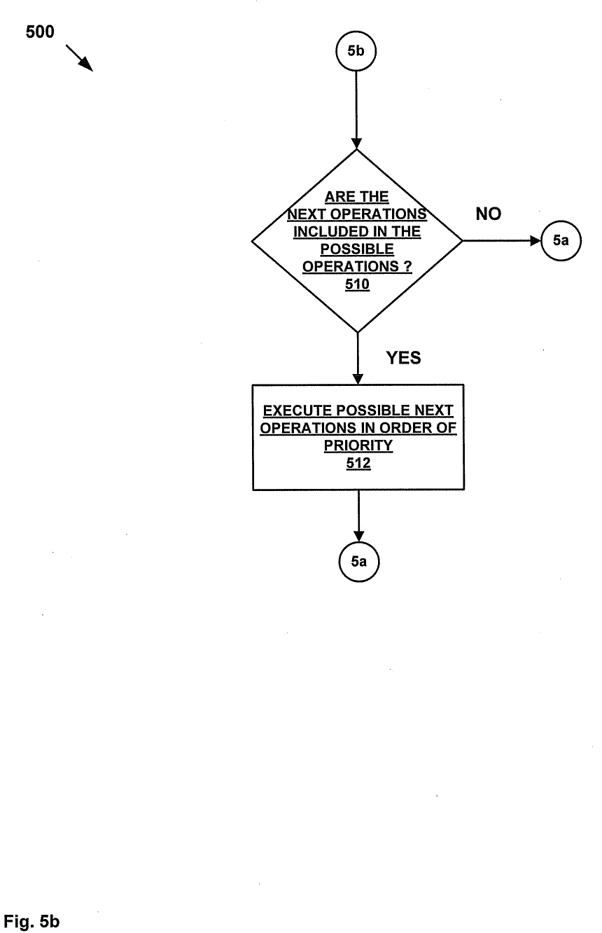

Referring now to FIGS. 5a and 5b, in an exemplary embodiment, one or more of the sensor nodes 102 of the system 100 implement a method 500 of operating in which, in 502, the sensor node determines if there is any power available to the sensor node. If there is any power available to the sensor node 102, then the sensor node determines if there is enough power available to the sensor node to permit the sensor node to execute at least one operation in 504.

If there is enough power available to permit the sensor node 102 to execute at least one operation, then the sensor gets a listing of the possible operations given the amount of available power in 506. The sensor node 102 then gets a listing of the current and next operational states for the sensor node in 508.

The sensor node 102 then determines if the next operational states of the sensor node are included in the possible operations given the amount of available power in 510. If the next operational states of the sensor node 102 are included in the possible operations given the amount of available power, then the sensor node executes the next operational states, based upon their pre-determined priority, that are possible to execute given the amount of available power in 512.

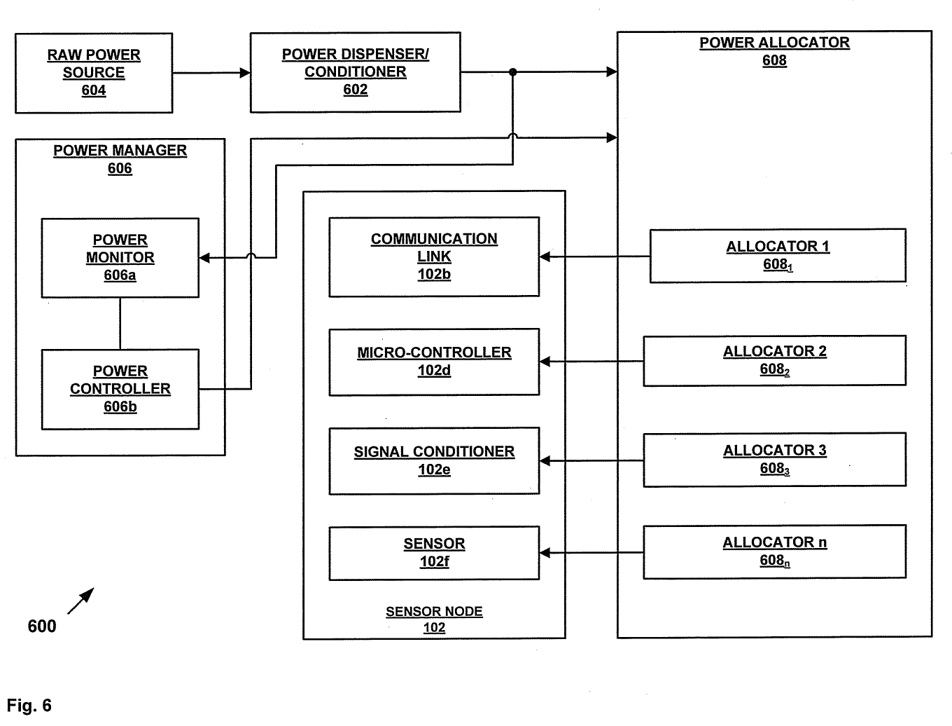

Referring now to FIG. 6, an exemplary embodiment of a system 600 for monitoring an aircraft is substantially identical in design and operation as the system 100 with the addition of a power dispenser and conditioner 602 that is operably coupled to a source of raw power 604, a power manager 606, a power allocator 608.

In an exemplary embodiment, the source of raw power 608 may include one or more of the power supplies 102a of one or more of the sensor nodes 102. In an exemplary embodiment, the power dispenser and conditioner 602 is adapted to receive time varying raw power, P(t)_{raw}, from the source of raw power 604, condition the raw power, and then transmit time varying available power, P(t)ₐᵥₐᵢₗ, to the power allocator 608. In an exemplary embodiment, the power dispenser and conditioner 602 includes one or more elements for conditioning the raw power such as, for example, a rectifier and a filter.

In an exemplary embodiment, the power manager 606 includes a power monitor 606a and a power controller 606b. In an exemplary embodiment, the power monitor 606a is operably coupled to the output of the power dispenser and conditioner 602 for monitoring the available power, P(t)ₐᵥₐᵢₗ. In an exemplary embodiment, the power monitor 606a is also operably coupled to the power controller 606b for communicating the available power, P(t)ₐᵥₐᵢₗ, to the power controller. In an exemplary embodiment, the power controller 606b is also operably coupled to the power allocator 608 for controlling the operation of the power allocator.

In an exemplary embodiment, the power allocator 608 includes one or more allocators 608i that are each coupled to one or more elements of the sensor node 102 for controllably supplying power to the corresponding elements of the sensor node. In this manner, the power manager 606 and the power allocator 608 collectively determine the power available to the sensor node 102 and then allocate the available power to the elements of the sensor node.

In an exemplary embodiment, the system 600 may implement one or more aspects of the methods 400 and 500, described and illustrated above with reference to FIGS. 4a, 4b, 5a, and 5b. In an exemplary embodiment, the elements and functionality of the power dispenser and conditioner 602, the raw power source 604, the power manager 606, and the power allocator 608 may be provided within one or more of the sensor nodes 102 and/or provided within the central controller 104.

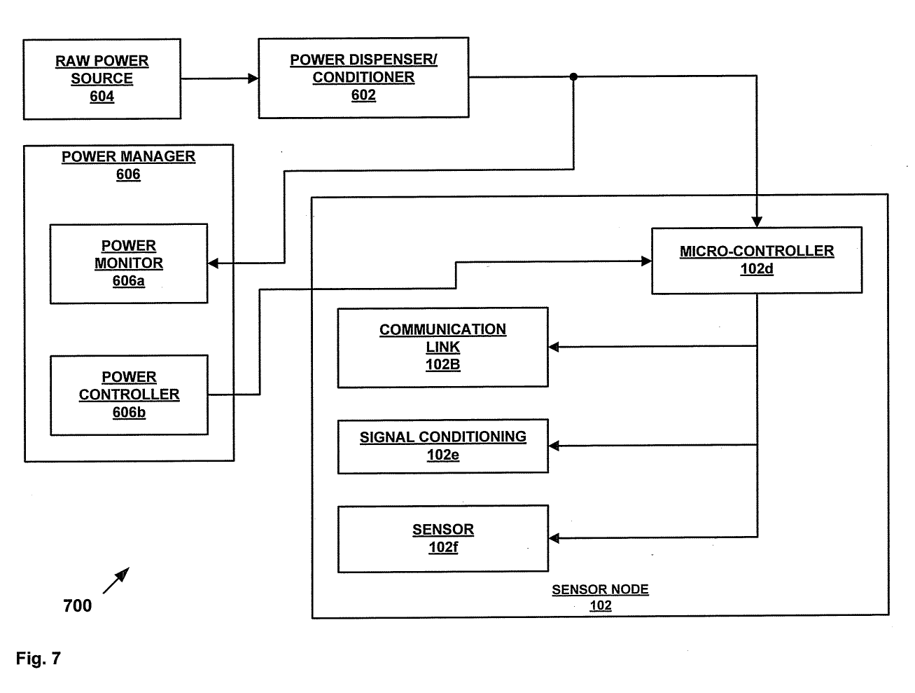

Referring now to FIG. 7, an exemplary embodiment of a system 700 for monitoring an aircraft is substantially identical in design and operation as the system 600 except that the power allocator 608 is omitted and the functionality formerly provided by the power allocator is provided by the micro-controller 102d within the sensor nodes 102.

In particular, in the system 700, the power controller 606b is operably coupled to the micro-controller 102d of the sensor node 102 for directing the allocation of the available power by the micro-controller to the elements of the sensor node.

In an exemplary embodiment, the system 700 may implement one or more aspects of the methods 400 and 500, described and illustrated above with reference to FIGS. 4a, 4b, 5a, and 5b. In an exemplary embodiment, the elements and functionality of the power dispenser and conditioner 602, the raw power source 604, and the power manager 606 may be provided within one or more of the sensor nodes 102 and/or provided within the central controller 104.

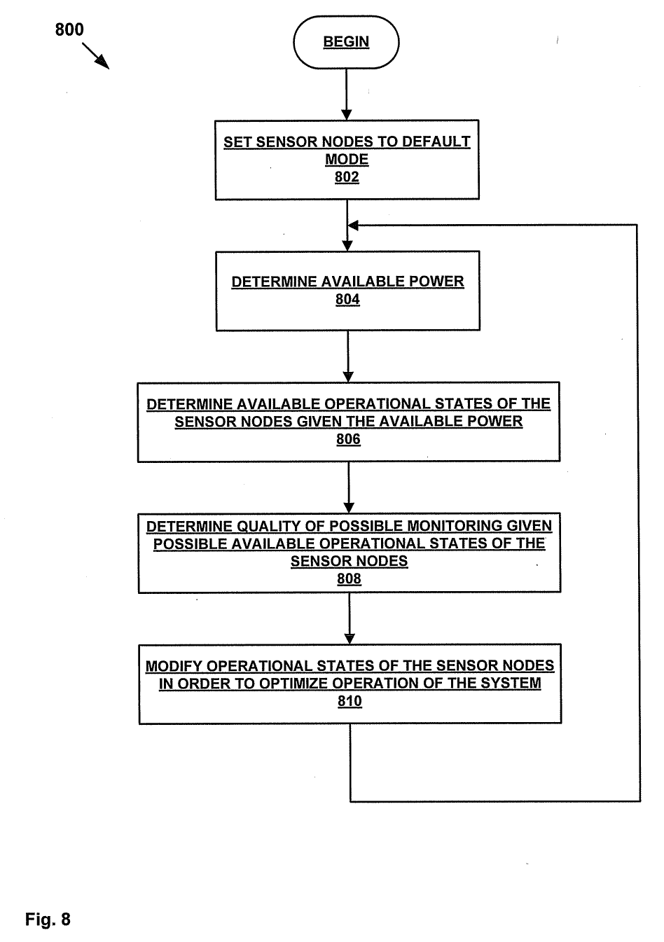

Referring now to FIG. 8, in an exemplary embodiment, one or more of the systems 100, 600, and 700 may implement a method 800 of operating in which, in 802, the sensor nodes 102 are placed into a default mode of operation which may, for example, include a sleep mode in which the sensor node is inactive, a fully active mode in which the sensor node is fully active, or one or more intermediate active modes in which the sensor node has functionality that is less than in the fully active mode. In 804, the system, 100, 600, or 700, will then determine the amount of power available to the system. In an exemplary embodiment, in 806, the system, 100, 600, or 700, will then determine the available operational states of the sensor nodes 102 of the system given the amount of power available to the system.

In an exemplary embodiment, in 808, the system, 100, 600, or 700, will then determine the quality of the possible monitoring of the aircraft 108 given the available operational states of the sensor nodes 102 of the system given the amount of power available to the system. In an exemplary embodiment, the quality of the possible monitoring of the aircraft 108 may be a function of what monitoring is adequate based upon the operating envelope and actual operating condition of the aircraft. For example, when the aircraft 108 is cruising at high altitudes with minimal turbulence, the level of detail and sampling rate in the monitored conditions may be less than when the aircraft is climbing to, or diving from, altitude with heavy turbulence.

In an exemplary embodiment, in 810, the system, 100, 600, or 700, will then modify the operational states of the sensor nodes 102 in order to optimize one or more of: 1) the available operational states of the sensor nodes, 2) the volume of data collected by the sensor nodes, 3) the sampling rate of the data collected by the sensor nodes, 4) the communication throughput of data within the network 106, and/or 5) the quality of the possible monitoring.

In an exemplary embodiment, during the operation of the systems, 100, 600 and/or 700, the switches, 102c, 102g and 102h, may be operated by the micro-controller 102d to place the sensor node 102 in a sleep mode by not permitting operation of the communication link 102b and the sensor 102f. In this manner, the use of power by the sensor node 102 is minimized.

In an exemplary embodiment, during the operation of the systems, 100, 600 and/or 700, the sensor node 102 may be operated in a sleep mode of operation that may, for example, include a range of sleeping mode that may vary from a deep sleep to a light sleep. In an exemplary embodiment, in a deep sleep mode of operation, the sensor node 102 may be completely asleep and then may be awakened by a watch dog timer, or other alert. In an exemplary embodiment, in a light sleep mode of operation, some of the functionality of the sensor node 102 may be reduced. In an exemplary embodiment, in one or more intermediate sleeping modes of operation, the functionality of the sensor node 102 will range from a standby mode, to a light sleep, to a deep sleep.

In an exemplary embodiment, in one or more of the systems 100, 600 and 700, one or more of the elements and functionality of the power dispenser and conditioner 602, the raw power source 604, the power manager 606, and the power allocator 608 may be provided within a sensor node 102, within one or more groups of sensor nodes, and/or within the central controller 104.

In an exemplary embodiment, in one or more of the systems, 100, 600 and 700, one or more of the elements and functionality of the raw power source 604 may be provided within a single sensor node 102, within one or more groups of sensor nodes, or by all of the sensor nodes. For example, if the power supply 102a in each of the sensor nodes 102 within one of the systems, 100, 600 or 700, is a solar cell, then the level of solar energy at each sensor node 102 will vary as a function of its location on the aircraft 108. In an exemplary embodiment, the allocation of power within the sensor nodes 102 of the systems, 100, 600 and 700, will determine the mapping of the power generated by the sensor nodes and then allocate power among the sensor nodes in order to optimize the operation of the systems in monitoring the aircraft 108.

In an exemplary embodiment, in one or more of the systems 100, 600 and 700, one or more of the sensor nodes 102 may provide one or more of the elements and functionality of the central controller 104.

In an exemplary embodiment, one or more of the systems 100, 600 and 700, may be operated to provide an optimal quality of the possible monitoring of the aircraft 108 by placing one or more determined sensor nodes 102 into a sleep mode, even in the presence of adequate power to operate the determined sensor nodes if the systems determine that the optimal quality of the possible monitoring of the aircraft can still be achieved. In this manner, the determined sensor nodes 102 placed into a sleep mode may do one or more of: store power or store data within the determined sensor node. In this manner, data may be warehoused within a sensor node 102 for later use and/or power may be stored within the sensor node for later use.

In an exemplary embodiment, one or more of the systems 100, 600 and 700, may be operated to place one or more determined sensor nodes 102 into a sleep mode if the data for the determined sensor node may be extrapolated using the data available for adjacent sensor nodes.

It is understood that variations may be made in the above without departing from the scope of the invention. While specific embodiments have been shown and described, modifications can be made by one skilled in the art without departing from the spirit or teaching of this invention. The embodiments as described are exemplary only and are not limiting. Many variations and modifications are possible and are within the scope of the invention. Accordingly, the scope of protection is not limited to the embodiments described, but is only limited by the claims that follow, the scope of which shall include all equivalents of the subject matter of the claims.

1. A distributed monitoring system for monitoring one or more operating conditions of a structure, comprising:
one or more sensor nodes coupled to the structure, each sensor node comprising:
a power supply;
a sensor operably coupled to the power supply for sensing one or more operating conditions of the structure in the immediate environment; and
a communications interface operably coupled to the power supply and the sensor for communicating the sensed operating conditions of the structure;
a communication network operably coupled to the sensor nodes; and
a controller operably coupled to the communication network for monitoring the sensor nodes.

2. The system of claim 1, wherein the sensor node comprises:
a first switch operably coupled between the sensor and the power supply for controlling the supply of power to the sensor;
a second switch operably coupled between the sensor and the communications interface for controlling the communication of the sensed operating conditions of the aircraft; and
a controller operably coupled to the first and second switches for controlling the operation of the first and second switches.

3. The system of claim 1, wherein the controller is adapted to determine the amount of available power provided by the power supply; and wherein the controller is adapted to control the operation of at least one of the first and second switches as a function of the available power.

4. The system of claim 1, wherein the controller is adapted to determine the amount of available power provided by the power supply; and wherein the controller is adapted to determine if the amount of available power will permit the sensor node to execute any possible next operations.

5. The system of claim 4, wherein the controller is adapted to execute the possible next operations using the available power.

6. The system of claim 5, wherein the controller is adapted to determine a priority order of the next possible operations; and wherein the controller is adapted to execute the possible next operations using the available power in the priority order.

7. The system of claim 1, further comprising:
a power allocator operably coupled to the sensor node for allocating power to the sensor and the communication interface.

8. The system of claim 1, further comprising:
an optimizing engine operably coupled to the sensor node adapted to control an operational state of the sensor node as a function of at least one of the following:
an amount of available power provided by the power supply; and
a quality of the monitoring of the operational conditions of the structure.

9. The system of claim 1, wherein the optimizing engine is adapted to place the sensor node in at least one of the following operational states:
a standby mode;
a sleep mode;
a fully active mode; and
an intermediate active mode.

10. The system of claim 1, wherein the power supply comprises a power scavenger for scavenging power from the immediate environment.

11. The system of claim 10, further comprising:
a remote power source for transmitting power to the power scavenger.

12. The system of claim 1, wherein the structure comprises an aircraft.

13. A method of operating a system for monitoring one or more operating conditions of a structure, comprising:
providing power at sensor node locations around the structure;
using the power to sense one or more operating conditions of the structure at the sensor node locations; and
using the power to transmit the sensed operating conditions from the sensor node locations.

14. The method of claim 13, further comprising:
determining an amount of the available power; and
controlling at least one of the sensing and the transmitting at the sensor node locations as a function of the determined amount of available power.

15. The method of claim 13, further comprising:
determining an amount of the available power at the sensor node locations;
determining an extent to which the amount of available power at the sensor node will permit the sensing and transmitting; and
controlling at least one of the sensing and the transmitting at the sensor node locations to the extent to which the determined amount of available power will permit sensing and the transmitting.

16. The method of claim 15, further comprising:
determining a priority order of the sensing and transmitting; and
executing the sensing and transmitting in the priority order.

17. The method of claim 16, further comprising:
allocating power to the sensing and the transmitting as a function of one or more predetermined variables.

18. The method of claim 16, further comprising:
controlling the sensing and transmitting as a function of at least one of the following:
an amount of available power at the sensor node; and
a quality of the monitoring of the operational conditions of the structure.

19. The method of claim 16, further comprising placing one or more of the sensor nodes in one of the following operational states:
a sleep mode;
a fully active mode; and
an intermediate active mode.

20. The method of claim 13, wherein providing power at sensor node locations around the structure comprises:
scavenging power from the immediate environment at sensor nodes.

21. The method of claim 20, wherein providing power at sensor node locations around the structure comprises:
transmitting power to one or more of the sensor nodes from a remote location.

22. The method of claim 13, wherein the structure comprises an aircraft.

23. A sensor node for use in a distributed monitoring system for monitoring one or more operating conditions of a structure, comprising:
a power supply;
a sensor operably coupled to the power supply for sensing one or more operating conditions of the structure in the immediate environment;
a communications interface operably coupled to the power supply and the sensor for communicating the sensed operating conditions of the structure; and
a controller operably coupled to the power supply, the sensor, and the communications interface.

24. The sensor node of claim 23, wherein the sensor node comprises:
a first switch operably coupled between the sensor and the power supply for controlling the supply of power to the sensor;
a second switch operably coupled between the sensor and the communications interface for controlling the communication of the sensed operating conditions of the aircraft; and
a controller operably coupled to the first and second switches for controlling the operation of the first and second switches.

25. The sensor node of claim 24, wherein the controller is adapted to determine the amount of available power provided by the power supply; and wherein the controller is adapted to control the operation of at least one of the first and second switches as a function of the available power.

26. The sensor node of claim 24, wherein the controller is adapted to determine the amount of available power provided by the power supply; and wherein the controller is adapted to determine if the amount of available power will permit the sensor node to execute any possible next operations.

27. The sensor node of claim 26, wherein the controller is adapted to execute the possible next operations using the available power.

28. The sensor node of claim 27, wherein the controller is adapted to determine a priority order of the next possible operations; and wherein the controller is adapted to execute the possible next operations using the available power in the priority order.

29. The sensor node of claim 23, further comprising:
a power allocator operably coupled to the sensor node for allocating power to the sensor and the communication interface.

30. The sensor node of claim 23, further comprising:
an optimizing engine operably coupled to the sensor node adapted to control an operational state of the sensor node as a function of at least one of the following:
an amount of available power provided by the power supply; and
a quality of the monitoring of the operational conditions of the structure.

31. The sensor node of claim 23, wherein the optimizing engine is adapted to place the sensor node in at least one of the following operational states:
a standby mode;
a sleep mode;
a fully active mode; and
an intermediate active mode.

32. The sensor node of claim 23, wherein the power supply comprises a power scavenger for scavenging power from the immediate environment.
